(19) United States
(12) Patent Application Publication
(10) Pub. No.: US 2011/0011760 A1
(43) Pub. Date: Jan. 20, 2011

(54) LIVE DEVICE SEIZURE KIT

(75) Inventor: Vernon Habersetzer, Rogers, AR (US)

Correspondence Address: SNR DENTON US LLP, P.O. BOX 061080, CHICAGO, IL, 60606-1080, US

(73) Assignee: WAL-MART STORES, INC.

(21) Appl. No.: 12/835,977

(22) Filed: Jul. 14, 2010

Related U.S. Application Data
(60) Provisional application No. 61/225,457, filed on Jul. 14, 2009.

(51) Int. Cl. B65D 85/00; B23P 17/04

(52) U.S. Cl. 206/320; 29/428

(57) ABSTRACT

A kit for containment, isolation, and transport of computer hardware, and related methods, are presented. The kit may include a case with a foam insert with a number of discrete sections sized and shaped to receive an Uninterruptible Power Supply, a network hub, a HotPlug device, a power strip, various tools, and computer hardware. The case may further include air vents and a lid that opens, closes, and latches securely for transport. The case may further include a lining to insulate the contents of the kit from RF signals during transport. The case may include handles and optionally wheels and an extendable handle to aid in the transport of the kit. The lid optionally includes various sized and shaped mesh pockets for holding power cords, extension cords and various other supplies and/or tools. Methods of manufacture and use are also presented.

### RELATED APPLICATIONS

This Application for Letters Patent claims priority to U.S. Provisional Patent Application Ser. No. 61/225,457, filed Jul. 14, 2009; the contents of which are incorporated herein by reference in their entirety.

### BACKGROUND

Transportation of computer hardware from one location to another can present problems if the computer hardware must remain “live” during transport. Computer hardware remains “live” as long as it is continuously connected to a power source. It is often desirable to transport a “live” computer to preserve the operational status of the computer for forensic analysis, maintenance or other purposes.

The WiebeTech HotPlug is a device that aids in live transportation of computer hardware by keeping power flowing to computer hardware while transferring the computer's power input from one A/C source, such as a wall outlet or power strip to another, such as a portable UPS, and then back again. While the WiebeTech HotPlug device helps to maintain constant power to the computer being transported, the computer, HotPlug device, and a power supply must be moved together as a single unit from the original location of the computer to the new desired location. Because these components tend to be bulky items, transporting the devices typically requires several people to work together to move the devices or requires the use of a lab cart, hand truck or some other transport apparatus. Moreover, because the devices are operating and generating heat, the devices must be moved in a manner that does not interfere with the fans or other cooling features of the devices. As a result, the devices are often moved through an open, unsecured environment. Thus, it would be beneficial to provide a means for transporting such devices in a secure manner that does not interfere with the cooling features of the devices.

In addition, while the WiebeTech HotPlug device helps to maintain constant power to the computer during transport, it is sometimes desirable to maintain a generally continuous connection to a network (or simulated network connection) also to prevent any change in operational status of the system. Thus, it would be beneficial to provide a system of transporting a computer or other device that maintains a generally continuous connection to a network, or simulated network, during live transport of the device.

### SUMMARY OF THE INVENTION

Shortcomings with aspects of conventional computer hardware containment, isolation and transportation systems are addressed as shown and described in a variety of illustrative embodiments herein. According to one illustrative embodiment, a kit for containment, isolation, and transport of computer hardware is presented. The kit may include a case with a foam insert (or other suitable material for partitioning sections within the case, including but not limited to plastic or plywood walls, walls of any other suitable material, or a combination of rigid or semi-rigid walls and foam material—all suitable partitioning materials generally referenced herein as “foam”). The foam insert may include a number of discrete sections, where each section may be sized and shaped to receive a specific component. Each section within the foam insert may be sized and shaped to restrict movement of a specific component within the case and between adjacent sections of the foam insert. Alternatively, rather than using foam to provide a “form fit” for devices that are placed into the kit, foam may be placed on bottom, top, and/or side inside surfaces of the case, thereby providing additional space not filled with foam within the case.

The case may include a lid that is secured by one or more hinges and can be opened and closed. When in the closed position, the lid may be latched to secure the lid in the closed position. The case includes at least one handle to aid in the transport of the kit. The case may optionally include wheels and an extendable handle to aid in the transport of the kit. The lid may further optionally include various sized and shaped mesh and/or zippered pockets for holding power cords, extension cords and various other supplies and/or tools, such as screwdrivers, electrical connectors, wire strippers, electrical tape, voltmeter, network cords, an electrical box, etc.

Within discrete sections of the case, the kit may further include at least one or more of the following components: an Uninterruptible Power Supply (UPS), a network hub, a HotPlug device (or other suitable device that provides continuous power to a computer while transferring power sources), a power strip, and various tools, such as a voltage detector, circuit tester, live wire power injection connectors, a Wiebetech PCD (or other suitable device that provides a way to inject power by making contact with the metal prongs of a power cord from the PC being seized), etc. The foam insert may further include a section for receiving the computer hardware, such as a desktop CPU, laptop computer, or other device being transported. In the event of a laptop computer being seized, a spacer may be utilized to maintain separation of the top and bottom portions of the laptop computer, thereby preventing the laptop computer from “sleeping” or going into a security mode. The spacer may be formed of one or more foam pieces that either secure onto the top and bottom portions of the laptop computer or are capable of being maintained in position between the top and bottom portions by using a strap to wrap around the laptop computer, thereby squeezing the foam pieces between the top and bottom portions of the laptop computer.

The case may further include air vents for the UPS and computer hardware to draw or exhale air. The case may further include a lining that attenuates RF signals to insulate the contents of the kit from RF signals that may interfere with the operational status of the computer during transport. The lining may be formed of copper, aluminum, Mylar, or any other RF attenuation material, as understood in the art. The lining material may be solid, mesh, or otherwise, and may be attached to one or more inside surfaces of the case. In one embodiment, at least a portion of the lining material may be in liquid form, such as Mylar paint, when placed into the case. Other RF attenuation material, such as RF absorbent foam, may be used and may double functionality by providing partitioning structure to secure or otherwise maintain position of the computer and/or other components being transported within the case.

According to another illustrative embodiment, a method of making a kit for containment, isolation, and transport of computer hardware is presented. The method may include modifying a standard case to include air vents in appropriate places to provide appropriate ventilation to a UPS and computer hardware. The method may further include forming and inserting within the modified case a foam insert with discrete sections for receiving a UPS, a network hub, a HotPlug device, a power strip, various tools, and computer hardware intended to be transported. The method may further include inserting and connecting the UPS, network hub, HotPlug device, and power strip such that the UPS and network hub device are adequately ventilated and ready to be connected to a live computer hardware for transport. The method may further include lining the modified case with RF attenuation material, such as a conductive metal mesh, to insulate the contents of the case from RF signals during transport.

According to another illustrative embodiment, a method of using a kit for containment, isolation, and transport of computer hardware is presented. The method may include connecting the HotPlug device to the live computer hardware device, optionally connecting the live computer hardware device to the network hub, disconnecting the live computer hardware device from its power source, disconnecting any other connections of the live computer hardware device, closing a lid of the kit, securing latch(es) of the kit, and transporting the kit and live computer hardware device to another location.

As further described herein, the kit allows for the secure transportation of a live device to a lab or other secure environment for analysis of the seized, running computer in the computer forensics lab or other controlled environment. The technician analyzing the computer can then analyze software that is running in memory, as well as analyze network connections the computer is attempting to make with other computers. By maintaining operation of the computer, the technician may analyze the way a virus or other malware behaves, which may not be feasible if the seized computer were turned off before being transported to the lab/controlled environment.

### BRIEF DESCRIPTION OF THE DRAWINGS

A more complete understanding of the principles of the present invention may be obtained by reference to the following Detailed Description when taken in conjunction with the accompanying Drawings wherein:

FIG. 1 is a front perspective view of an illustrative embodiment of a live device seizure kit of the present invention, including a lid in an open position;

FIG. 2 is a top view of the live device seizure kit of FIG. 1 with the lid omitted;

FIG. 3 is a front perspective view of the live device seizure kit of FIG. 1 with the lid in a closed position;

FIG. 4 is a rear perspective view of the live device seizure kit of FIG. 1 with the lid in a closed position;

FIG. 5 is another front perspective view of the live device seizure kit of FIG. 1 with the lid in a closed position;

FIG. 6 is a side view of the live device seizure kit of FIG. 1 with the lid in a closed position and an extendable handle in an extended position;

FIG. 7 is an illustration of an alternative illustrative kit for capturing and transporting a “live” computer;

FIG. 8 is a flow chart of an illustrative process for making a kit for capturing and transporting a “live” computer; and

FIG. 9 is a flow chart of an illustrative process of using a kit for capturing and transporting a “live” computer.

### DETAILED DESCRIPTION

In the following detailed description of the preferred embodiments, reference is made to the accompanying drawings that form a part hereof, and in which is shown, by way of illustration, specific embodiments in which the invention may be practiced. These embodiments are described in sufficient detail to enable those skilled in the art to practice the invention, and it is understood that other embodiments may be utilized and that logical structural, mechanical, electrical, and chemical changes may be made without departing from the scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

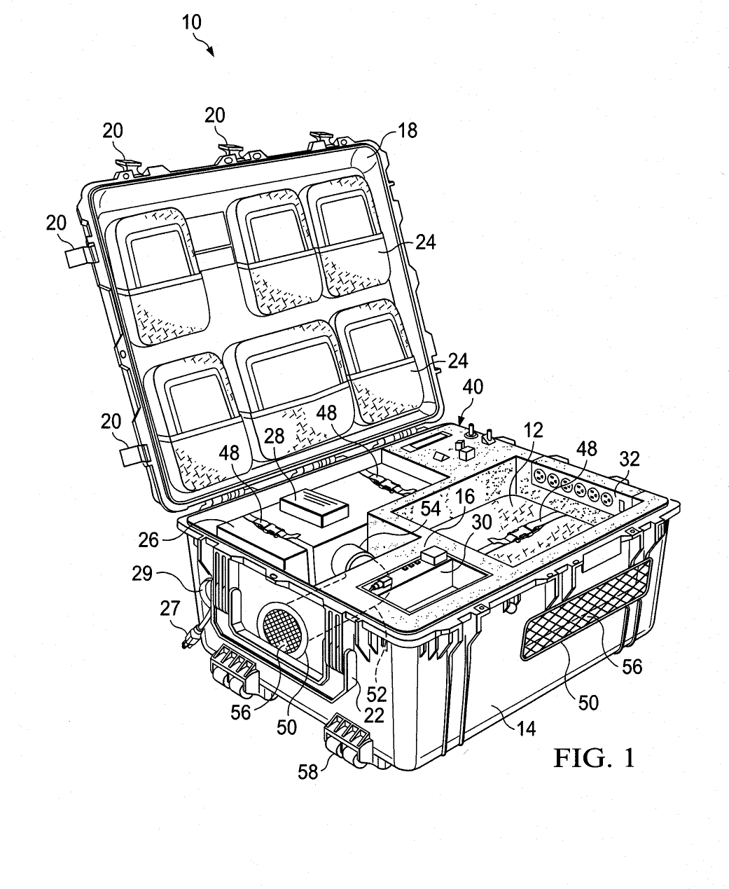

Referring now to FIG. 1, an illustrative embodiment of a live device seizure kit is presented. A kit 10 for containment, isolation, and transport of computer hardware 12 is presented. The kit 10 includes a case 14 that includes a bottom case member and upper case member or lid. A foam insert 16 may be positioned within the case to provide distinct regions in which components, such as a computer being transported, are to be positioned. In the embodiment shown in FIG. 1, foam insert 16 is a light, porous, semi-rigid or spongy material of the type typically used for thermal insulation and/or shock absorption. The foam may also have RF attenuation characteristics to reduce the ability for external RF signals to be received by the computer hardware 12 that is being transported. In an alternative embodiment, not shown, foam insert 16 may be a combination of the semi-rigid/spongy material shown in FIG. 1 and wood walls, optionally held together by aluminum brackets, and painted with prasti-coat rubberized paint may be utilized. The wood walls may provide separation between and/or help hold in place separate pieces of the semi-rigid/spongy material and/or components held within the case 14. It should be appreciated that alternative partitions, including plastic or wood walls with various forms of coating (such as paint, Formica, or any other covering material) and/or no coating at all, combinations of rigid and semi-rigid materials, or other suitable rigid or semi-rigid dividers may be utilized without departing from the principles of the instant invention. Furthermore, it should be appreciated that alternative means of connecting together divider sections or walls may be utilized without departing from the principles of the instant invention.

For purposes of example, and not by way of limitation, the case 14 may include a hard-sided Transport Case Model 1690 available from PELICAN PRODUCTS, INC. The foam insert 16 may include a number of discrete sections, where each section is sized and shaped to receive a specific component. Each section within the foam insert 16 may be sized and shaped to restrict movement of a specific component within the case 14 and between adjacent sections of the foam insert 16. The case 14 may include a lid 18 that can be opened and closed. Latches 20 may secure the lid 18 in the closed position. The case 14 may include at least one handle 22 to aid in the transport of the kit 10. As further shown in FIG. 1, the kit 10 further includes various sized and shaped mesh pockets 24. For example, and not by way of limitation, the mesh pockets 24 may include a Lid Organizer Model 1699, available from PELICAN PRODUCTS, INC.

As shown in FIG. 1, within discrete sections of the foam insert 16 of the case 14, the kit 10 further includes an Uninterruptible Power Supply (UPS) 26, a network hub 28, a HotPlug device 30, a power strip 32, and various tools 40 such as a voltage detector, circuit tester, live wire power injection connectors, a Wiebetech PCD (or other suitable device that provides a way to inject power by making contact with the metal prongs of a power cord from the PC being seized), etc. The above list is illustrative and may be altered by including fewer, more, or different devices. The UPS 26, for example, and not by way of limitation, may include Smart UPS 1500VA USB & Serial 120 V (part number SUA1500), available from AMERICAN POWER CONVERSION CORP. For example, and not by way of limitation, the network hub 28 may include a 4-port 10/100 Ethernet Hub (part number DX-EHB4 ), available from DYNEX. For example, and not by way of limitation, the HotPlug device 30 may include a HotPlug device (part number 30100-0000-0001), available from WIEBETECH. For example, and not by way of limitation, the various tools 40 may include a HotPlug accessory kit #2 (part number 30100-0000-0052), available from WIEBETECH. As further shown in FIG. 1, the kit 10 may include straps 48 to retain the UPS 26 and computer hardware 12 in place during transport. In an alternative embodiment, UPS 26 may be bolted to case 14. It will be appreciated that alternative means of retaining UPS 26, computer hardware 12 and any other components of kit 10 may be utilized without departing from the principles of the instant invention.

The power strip 32 may be plugged into a power outlet of the UPS 26 such that the UPS 26 supplies power to the power strip 32. In one embodiment, the cord of the power strip may be routed through channels within or underneath the foam insert 16 from the power strip 32 to the UPS 26, such that the cord of the power strip is concealed from view and out of the way when case 14 is open and/or in use. Case 14 may include portal 29 through which a power cord 27 of UPS 26 may be extended for supplying wall power to UPS 26 for prolonged operation and/or charging of UPS 26. In another embodiment, an output power cord from the HotPlug device 30 may be coiled up while not in use. In still another embodiment, an input power cord from the HotPlug device 30 may be routed through channels within or underneath the foam insert from the HotPlug device 30 to a power outlet of the UPS 26 or otherwise to a power outlet of the power strip 32.

The foam insert 16 may further include a section for receiving computer hardware 12, such as a desktop CPU or laptop computer. The case 14 may further include one or more air vents 50 for the UPS 26 and computer hardware 12. As shown in FIG. 1, the air vents 50 may include PVC conduit 52 and fittings 54 extending through the inside of the case 14 and foam insert 16 to a metal mesh/screen 56 at the exterior of the case 14. The case 14 may further include a lining having RF attenuation properties. The lining may be formed of copper or aluminum to insulate the contents of the kit 10 from RF signals during transport. The lining may be mesh or solid, or be formed from a liquid, such as paint. In one embodiment, HSF54 RF-shielding paint made by YShield (available at www.yshield.com) is used to coat the inner sides of case 14. In another embodiment, RF-shielding ARGENMESH (available at http://lessemf.com/fabric.html) may be used to cover the ventilation holes in the pelican case, to prevent RF from entering through the vents.

The network hub 28 may use Ethernet, USB or other suitable cables that extend from the hub through channels within or underneath the foam insert to the discrete section within the foam insert for the computer hardware 12 being transported. One of the cables is for connection to an appropriate port of the computer hardware being transported. In another embodiment, one of the cables may be used to connect to a “sniffing” laptop computer that is located inside the discrete section within the foam insert along with the computer hardware 12 being transported. The “sniffing” laptop computer includes software that monitors the activity of the computer hardware 12 and records network connection attempts made by the seized computer during transit, providing more data for analysis by a technician. In one embodiment, the software is Wireshark software, a freely available “sniffer” found at www.wireshark.org. The Wireshark is utilized to specify the network interface the sniffing laptop should use to capture traffic (packets). The software then listens for, and makes a copy of (i.e., records), any packets it sees on that network interface. By using a network hub, as opposed to a network switch, the sniffing computer sees any packets generated by either the sniffing computer or by the computer being seized. With an appropriate filter applied through the software, packets coming from the sniffing computer may be excluded.

The Wireshark software of this embodiment shows through its GUI (graphical user interface) the source and destination IP addresses of various packets, along with the network protocol and a description of the type of packet detected by the software. The Wireshark software also shows a detailed view of the contents of any packet that is highlighted by a user through the GUI. The Wireshark software displays the destination IP addresses the seized computer is trying to communicate with, along with the information contained in the packets being sent.

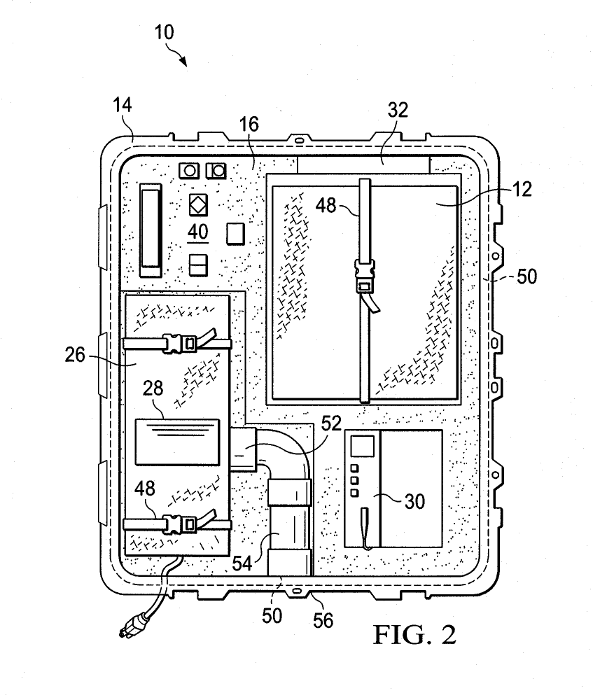

Referring to FIG. 2, an illustrative embodiment of the kit 10 is presented with the lid 18 removed for clarity of the contents of the case 14. FIG. 2 shows the arrangement of the foam insert 16 within the case 14. FIG. 2 also shows the configuration of the UPS 26, network hub 28, HotPlug device 30, power strip 32, tools 40, straps 48, air vents 50, PVC conduit 52, PVC fittings 54, and mesh/screen 56.

The air vents 50, PVC conduit 52, and PVC fittings 54 are positioned to associate with the various cooling features of the components contained within the case 14. For example, PVC conduit 52, PVC fittings 54, and circular air vent 50 to which those components connect, are associated with a cooling fan output of UPS 26. It should be understood that conduits and fittings made of material other than PVC may be utilized. In addition, the square-shaped air vent 50 located behind UPS 26 (shown in FIG. 4) is associated with the air intake of UPS 26. The long rectangular air vent 50 (shown in FIGS. 1, 3, 5 and 6) is associated with the cooling fans and intakes of the computer hardware 12 being transported.

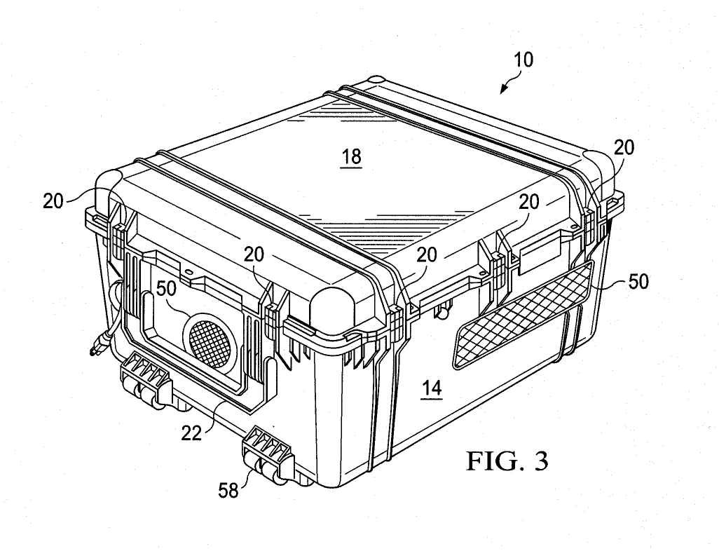

Referring to FIGS. 3-5, perspective views of an illustrative embodiment of the kit 10 is presented with the lid 18 in a closed position. As shown in FIGS. 3-5, the latches 20 are secured and the kit 10 is ready for relatively easy transport with the computer hardware 12 contained and isolated while maintaining a power connection via the UPS. FIGS. 3-5 show the arrangement of the handles 22 with respect to the case 14, lid 18, and air vents 50.

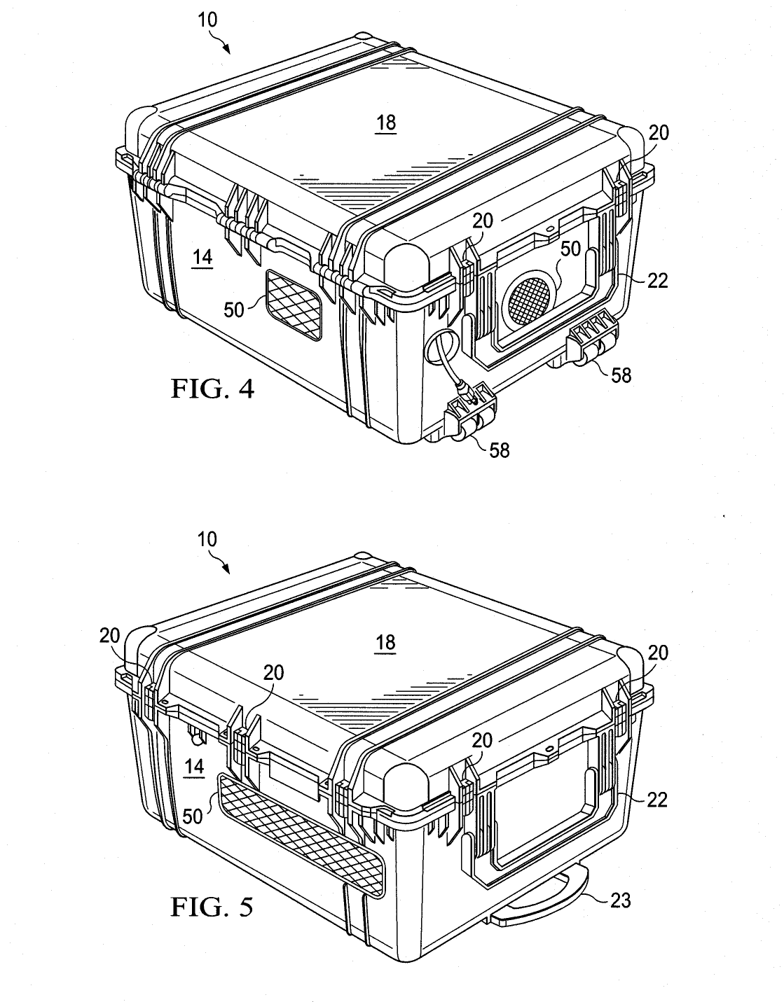

Referring to FIGS. 4 and 5, additional perspective views of an illustrative embodiment of the kit 10 is presented, with the lid 18 in a closed position. As shown in FIG. 3, the latches 20 are secured and the kit 10 is ready for relatively easy transport with the computer hardware 12 contained and isolated while maintaining a power connection via the UPS. FIG. 3 shows the arrangement of the handle 22 with respect to the case 14, lid 18, and air vents 50.

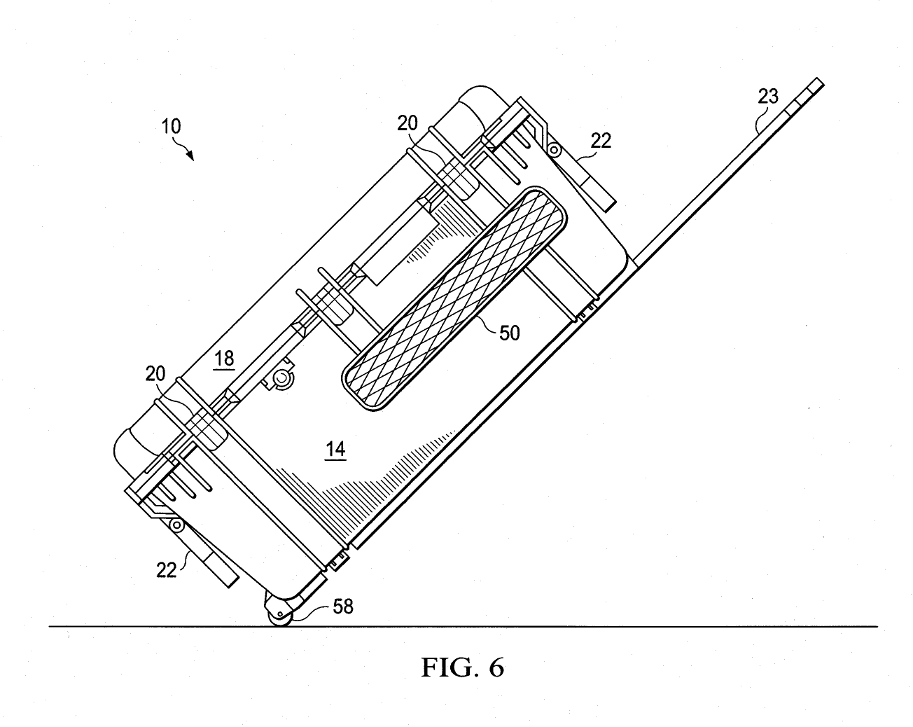

Referring to FIG. 6, a side view of an illustrative embodiment of the kit 10 is presented. The case 14 optionally includes wheels 58 and an extendable handle 23 to aid in the transport of the kit.

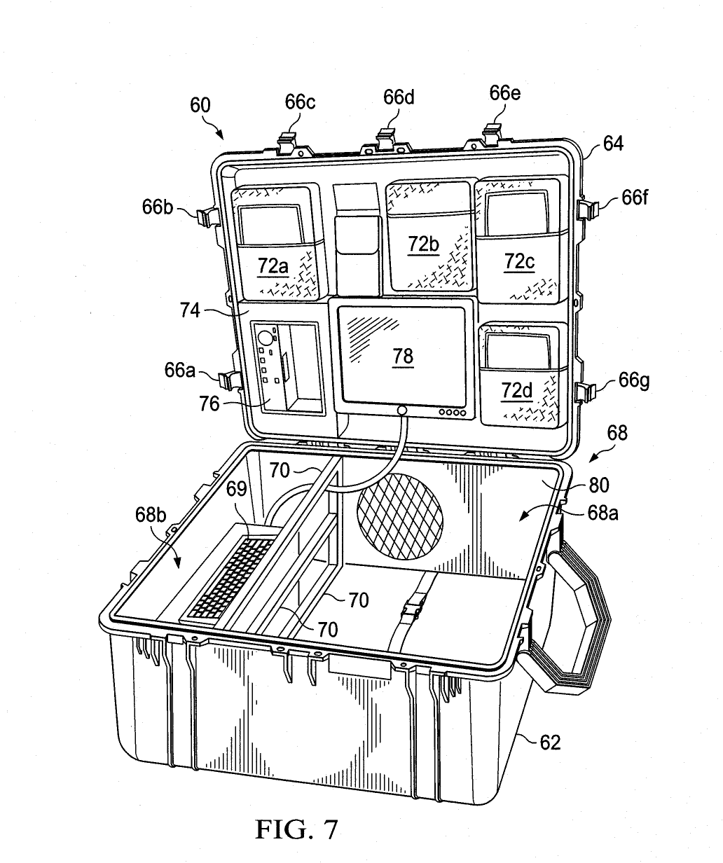

Referring to FIG. 7, an illustration of an alternative illustrative kit 60 for transporting a “live” computer is shown. The kit 60 is shown to include a bottom case member 62 (base) and top case member 64 (lid) to encase or enclose a computer being transported therein. The bottom case member 62 may be connected to the top case member 64 via hinges (not shown) in the art, as understood, and use one or more latches 66a-66g (collectively 66) positioned around the top and/or bottom members 62 and 64. A non-hinged configuration may alternatively be utilized.

The bottom case member 62 may define a main compartment 68 that is partitioned into two sub-compartments 68a and 68b by one or more partition or divider members 70 that extend between opposing internal walls of the bottom case member 62. The partition member(s) 70 shown may be metallic rods. Alternatively, non-metallic rods may be utilized. Still yet, rather than using rods, a mesh or solid partition structure or material may be utilized to partition the main compartment 68. Sub-compartment 68a may be large enough to have a desktop computer (not shown) positioned therein (not including monitor or other peripherals). Sub-compartment 68b may be large enough to have a UPS (not shown) positioned therein. In addition, other peripherals, such as a keyboard 69, computer mouse (not shown), power strip (not shown), etc., may be able to fit within one of the sub-compartments 68a and 68b of the main compartment 68. In one embodiment, restraints, such as a pouch or straps, may be configured in sub-compartment 68b to maintain position of the peripherals during transport.

The top case member 64 may have a number of different mesh pockets 72a-72d (collectively 72) that may be used to secure wires, cables, tools, electronics, or other devices that may be used for capturing and transporting “live” computer hardware. The mesh pockets 72 may include zippers, Velcro®, spring seal, or other mechanisms for preventing contents in the pocket from falling out. A retention structure or device 74 may be used to secure a HotPlug device 76 or other suitable device that provides continuous power to a computer while transferring the computer between power sources. In one embodiment, the retention structure 74 is a metallic casing that retains the HotPlug device 76. Alternatively, the retention structure 74 may be foam. Still yet, the retention structure 74 may be straps with a snap, Velcro®, buckle, or other means for holding the straps securely against the HotPlug device to prevent the HotPlug device from falling into the main compartment 68 or out of the kit 60. Of course, a combination of structural and retention members may be utilized.

The kit 60 may further include a monitor 78 that may be utilized in the field (e.g., during transport) by a user to connect to a computer being seized. The monitor 78 may be an appropriate size, such as 17 inches, to enable the user to easily view content being displayed while the user interacts with the computer. A securing mechanism, such as straps (not shown) or retention structure (not shown), may be utilized to secure the monitor 78 to the top case member 64. Other peripherals, such as a keyboard and computer mouse, may also be part of the kit 60 so that the user may interact with the computer in the field. A network hub (not shown) may also be maintained and secured in the kit 60, optionally in the sub-compartment 68b, to allow the user to have the computer maintain a network connection while being transported. As with the kit in FIGS. 1-6, the bottom and top case members 62 and 64 may have vents (not shown) and vent covers (not shown) to allow air to pass into and out of the kit 60 when the bottom and top case members 62 and 64 are closed with a “live” computer inside.

A lining 80 may be attached to inside surfaces of the bottom and top case members 62 and 64. The lining 80 may provide RF attenuation to reduce the amount of RF radiation that enters and exits the kit 60 when a “live” computer is being transported. The lining 80 may be formed of one or more RF attenuating or blocking materials, as previously described. In one embodiment, the lining 80 on the bottom case member 62 may be electrically connected to the lining 80 on the top case member 64, thereby providing for a more uniform RF shield than if the linings were not connected to one another. Although no foam is shown within the kit 60, it should be understood that foam structure(s) that are sized and shaped to retain a computer and peripherals, as shown and described in FIGS. 1-6, may be utilized in accordance with the principles of the present invention. However, such foam structure(s) are not necessary.

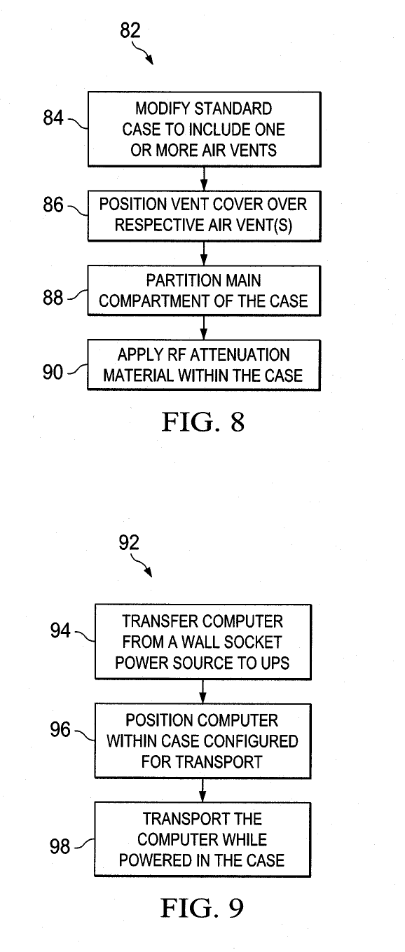

Referring to FIG. 8, a flow chart of a process 82 for making a kit for containment, isolation, and transport of “live” computer hardware is presented. The process 82 may include modifying a standard case to include air vents in appropriate places to provide appropriate ventilation to a UPS and computer hardware at step 84. The air vents may be made with PVC conduit and fittings and extend from the foam insert to the exterior of the case. Alternatively, the air vents may be formed of other material and simply be air vents that enable airflow through a wall of the case. At step 86, the air vents may be protected from foreign debris by positioning a vent cover over the air vents, where the vent cover may be a metal mesh/screen.

At step 88, a main compartment of the case may be partitioned. The partitioning may include partition structure element(s), such as metal, foam, cloth, or any other material that may be utilized to partition the main compartment into discrete compartments that may also furnish internal support for the various elements during transport. The method may further include forming and inserting within the modified case, a foam insert with discrete sections for receiving a UPS, network hub, a HotPlug device, a power strip, various tools, and computer hardware intended to be transported. The method may further include inserting and connecting the UPS, network hub, HotPlug device, and power strip in a manner that allows the UPS, network hub, and HotPlug device to be adequately ventilated and ready to be connected to a live computer hardware for transport in an efficient manner.

At step 90, a lining may be applied to the modified case, where the lining may provide RF attenuation within the case. In one embodiment, the lining may be formed with a conductive metal mesh to insulate the contents of the case from RF signals during transport. Alternatively and/or additionally, the lining may be formed by a paint that has RF attenuation properties.

Referring to FIG. 9, a process 92 of using a kit for containment, isolation, and transport of “live” computer hardware is presented. The process 92 may include transferring a computer from a wall socket power source to a UPS at step 94. The wall socket power source may be provided directly by a wall socket to a power cord to which the computer is connected or the computer may be connected to a power strip. In one embodiment, a HotPlug device or other power transfer device may be used to perform transfer step 94. Optionally, depending on the current state of the computer when being transferred, the live computer hardware device may be connected or otherwise communicated with the network hub. The transferring step 94 may further include disconnecting any other connections of the live computer hardware device. At step 96, the computer may be positioned within a case configured for transport of the computer, UPS, and other components of the kit. The lid of the kit may be closed and secured. At step 98, the kit and live computer hardware device may be transported to another location. If the kit includes wheels and an extendable handle, the computer may be wheeled at least part of the way to a destination.

Although the present invention and its advantages have been disclosed in the context of certain illustrative, non-limiting embodiments, it should be understood that various changes, substitutions, permutations, and alterations can be made without departing from the scope of the invention as defined by the appended claims. It will be appreciated that any feature that is described in a connection to any one embodiment may also be applicable to any other embodiment.

What is claimed:

1. A computer transport case, comprising:
a first case member; and
a second case member configured to connect to said first case member to encase a computer between said first and second case members, at least one of said first and second case members having an air vent configured to enable air to pass through the at least one of said first and second case members, said first and second case members having RF attenuation material disposed therebetween to reduce RF radiation from entering and exiting the case.

2. The computer transport case according to claim 1, wherein said first case member includes at least one divider structural member configured to divide said first case member into multiple compartments, a first compartment sized to enable the computer to reside in the first compartment when said first and second case members are connected together, and a second compartment sized to enable an uninterruptable power supply to reside in the second compartment when said first and second case members are connected together.

3. The computer transport case according to claim 2, wherein said second case member includes at least one mesh pocket to enable accessories, such as cables, to be neatly packed in the case.

4. The computer transport case according to claim 2, wherein the computer is a desktop computer.

5. The computer transport case according to claim 2, wherein the uninterruptable power supply is capable of powering the computer during transport to a destination location whereupon non-temporary power can be resumed.

6. The computer transport case according to claim 1, further comprising foam connected to inside portions of said first and second case members.

7. The computer transport case according to claim 1, wherein the RF attenuation material includes Mylar.

8. A kit for transporting a live computer, said kit comprising:
a case including at least two partitions within a main compartment of the case, said case further including RF attenuation material to reduce electromagnetic radiation from entering the main compartment of the case, said case further including at least one vent to enable air flow with the air outside the main compartment when said case is closed;
an uninterruptable power supply positioned in one of the partitions within the main compartment; and
an electrical device configured to enable a user to unplug a computer being powered by a wall socket without losing power while transitioning the computer to be powered by said uninterruptible power supply.

9. The kit according to claim 8, wherein the case includes a structural element that partitions the main compartment of the case, the structural element including rods that extend between two opposing internal walls of the case.

10. The kit according to claim 8, wherein the RF absorbent material includes Mylar.

11. The kit according to claim 8, wherein said case further comprising straps configured to secure the computer within one of the partitions within the case.

12. The kit according to claim 8, further comprising a network hub configured to enable the computer to maintain communication with a communications network while being transported.

13. The kit according to claim 8, further comprising a computer monitor and one or more input peripherals to enable the user to connect with the computer to interact with operations of the computer.

14. A method of manufacturing a computer transport case, said method comprising:
modifying a standard case to include one or more air vents;
positioning a vent cover over respective one or more air vents;
partitioning a main compartment of the case; and
applying RF attenuation material within the case.

15. The method according to claim 14, further comprising positioning an uninterruptable power supply within the case.

16. The method according to claim 14, further comprising connecting mesh pockets to an inside wall of a lid of the case, the mesh pockets being configured to retain cables and tools.

17. The method according to claim 14, further comprising connecting retention elements to secure a computer in one of the partitions with the main compartment of the case.

18. The method according to claim 14, further comprising connecting a retention component to retain an electronic device configured to enable a user to maintain power of a computer while transferring the computer between a wall socket power source and uninterruptable power supply.

19. A method for using a kit for transporting a computer, said method comprising:
transferring the computer from a wall socket power source to an uninterruptable power supply;
positioning the computer within a case configured to transport the computer and uninterruptable power supply; and
transporting the computer while powered in the case.

20. The method according to claim 19, further comprising allowing the computer to communicate with a network hub positioned in the case.

21. The method according to claim 19, further comprising reducing RF communications by the computer with electronic devices outside the case while being transported.

22. The method according to claim 19, further comprising connecting one or more electronic peripheral components to the computer that are stored in the case and available for use with computers that are transported.
